(19) United States
(12) Patent Application Publication
(10) Pub. No.: US 2005/0194108 A1
(43) Pub. Date: Sep. 8, 2005

(54) Automobile curtain device

(76) Inventor: Chen-Hsing Lin, Chupei City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/795,658

(22) Filed: Mar. 8, 2004

(51) Int. Cl. B60J 1/20

(52) U.S. Cl. 160/370.21

(57) ABSTRACT

An automobile curtain device has at least one track, at least one curtain assembly, at least one cord and a driving device. The at least one track is mounted on an automobile window. The at least one cord is mounted in the track. The at least one curtain assembly is mounted on the at least one track and is connected to the at least one cord that is driven by the driving device to open or close the at least one curtain assembly.

### BACKGROUND OF THE INVENTION

1. Field of the Invention

The present invention relates to a curtain device, and more particularly to an automobile curtain device having a motor to open or close a curtain mounted on an automobile window.

2. Description of Related Art

A conventional curtain device is not usually motor driven and is operated manually by a user. Therefore, a person has to manually close or open a conventional curtain mounted on an automobile window. Since an automobile has multiple windows, opening or closing all the curtains mounted respectively on the automobile windows is inconvenient. Therefore, the conventional curtain device for an automobile is inconvenient and time consuming to use.

To overcome the shortcomings, the present invention provides an automobile curtain device to mitigate or obviate the aforementioned problems.

### SUMMARY OF THE INVENTION

The main objective of the invention is to provide an automobile curtain device that will open or close curtains mounted respectively on automobile windows.

An automobile curtain device in accordance with the present invention comprises at least one track, a curtain assembly, at least one cord and a driving device.

The curtain assembly is mounted on the at least one track and is connected to the at least one cord that is driven by the driving device to open or close the curtain assembly.

Further benefits and advantages of the present invention will become apparent after a careful reading of the detailed description with appropriate reference to the accompanying drawings.

### BRIEF DESCRIPTION OF THE DRAWINGS

FIG. 1 is a front plan view of an automobile curtain device in accordance with the present invention;

FIG. 2 is an enlarged perspective view of the automobile curtain device in FIG. 1;

FIG. 3 is a perspective view of an automobile with the automobile curtain device in FIG. 1;

FIG. 4 is a front plan view of another embodiment of an automobile curtain device in accordance with the present invention; and

FIG. 5 is an enlarged perspective view of the automobile curtain device in FIG. 4.

### DETAILED DESCRIPTION OF PREFERRED EMBODIMENT

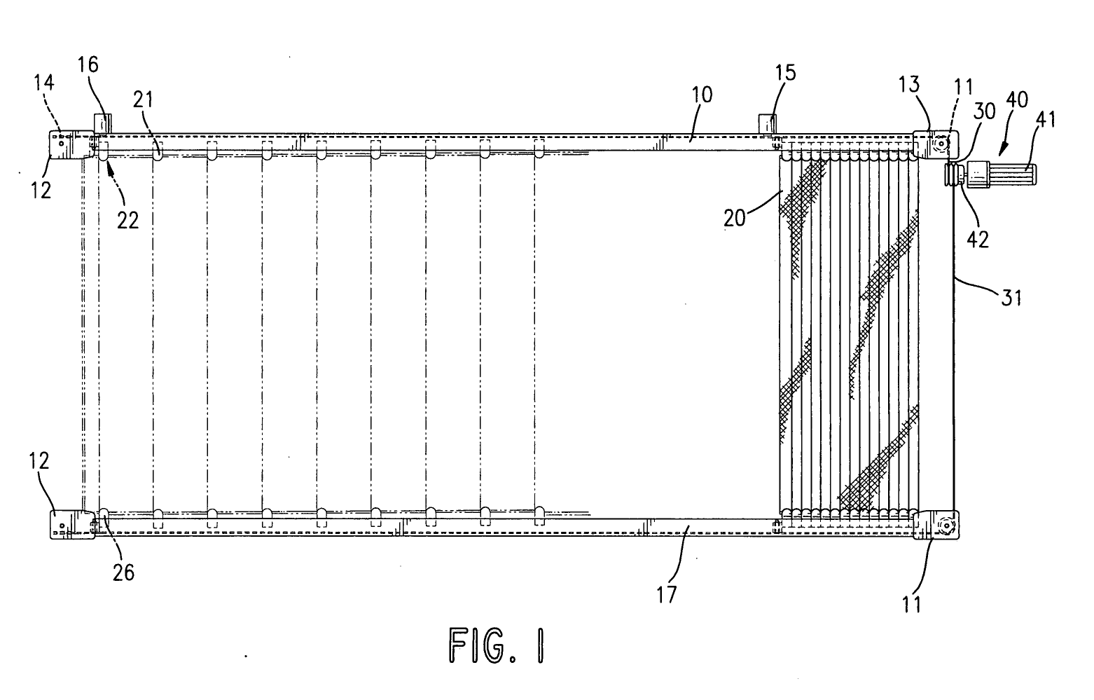

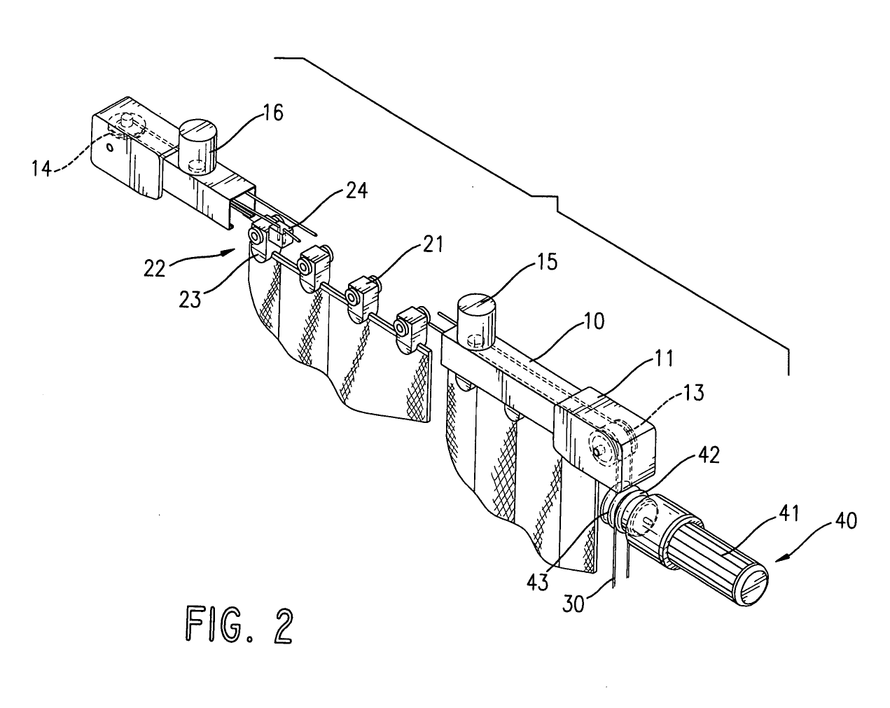

With reference to FIGS. 1 and 2, an automobile curtain device in accordance with the present invention comprises a top track (10), an optional bottom track (17), a first curtain assembly (not numbered), a top cord (30), an optional bottom cord (31) and a driving device (40).

The top track (10) and the optional bottom track (17) are mounted respectively at the top and bottom of an automobile window. Each of the tracks (10, 17) has a first end (not numbered), a second end (not numbered), a first bracket (11), a second bracket (12), a corner sheave (13), a return sheave (14), an optional open sensor (15) and an optional closed sensor (16).

The first bracket (11) is mounted at the first end of each track (10, 17), and the second bracket (12) is mounted at the second end of each track (10, 17).

The corner sheaves (13) and the return sheaves (14) are mounted respectively in the first and second brackets (11, 12). Each corner sheave (13) has two swallows (not numbered), and the corner sheaves (13) are mounted and vertically rotate respectively in the first brackets (11). The return sheaves (14) respectively have a single swallow (not numbered), are mounted and horizontally rotate respectively in the second brackets (12).

The optional open sensor (15) is mounted on the top track (10) near the first bracket (11), and the optional closed sensor (16) is mounted on the top track (10) next to the second bracket (12).

The first curtain assembly has a first curtain (20), multiple sliding curtain fasteners (21) and a top driver (22) and an optional bottom driver (26).

The first curtain (20) has a top edge (not numbered), a bottom edge (not number), a stationary end (not numbered) and a moveable end (not numbered).

Multiple sliding curtain fasteners (21) are mounted in the top track (10) and the optional bottom track (17) and are attached respectively to the top edge and the bottom edge of the first curtain (20). Adjacent sliding curtain fasteners (21) are attached to the first curtain (20) at intervals. The sliding curtain fasteners (21) on the bottom edge of the first curtain (20) correspond to the sliding curtain fasteners (21) on the top edge of the first curtain (20).

Each driver (22, 26) has a sliding portion (23) and a mounting portion (24). When the optional bottom track (17) is applied, the top driver (22) and bottom driver (26) are mounted respectively on the top track (10) and the optional bottom track (17). The sliding portions (23) are mounted respectively inside the top track (10) and the optional bottom track (17). The mounting portions of the two drivers (22) are respectively attached to the top and bottom edges of the first curtain (20) at the moveable end of the first curtain (20).

Each cord (30, 31) has two ends (not numbered), forms a loop (not numbered), is reeved around the corresponding corner sheave (13) and the corresponding return sheave (12) and is mounted in the corresponding top and optional bottom track (10, 17). The top cord (30) and optional bottom cord (31) are connected respectively to the mounting portions of the top driver (22) and the optional bottom driver (22).

The driving device (40) is mounted below the top track (10) and between the two tracks (10, 17) when a bottom track (17) is included at the stationary end of the first curtain (20) and has a motor (41) and a wheel (42). The motor (41) has a drive shaft (not numbered) that extends from the motor (41). The wheel (42) is mounted on the drive shaft and has at least one annular grooves (not numbered) around which the top cord (30) and the bottom cord (31) are looped and driven by the motor (41).

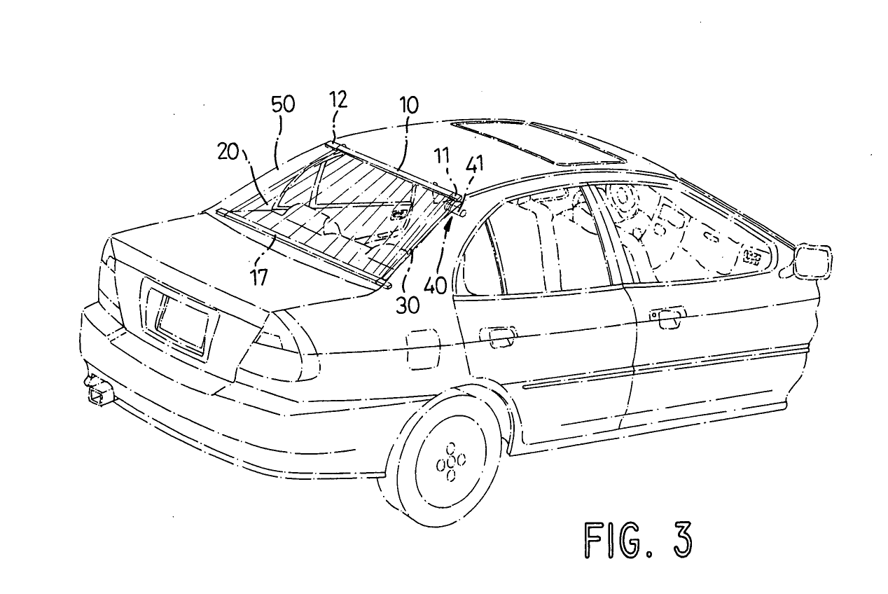

With further reference to FIG. 3, the top track (10) and the optional bottom track (17) are mounted respectively on top and bottom edges of an automobile window (50). A remote or dashboard control (not shown) is used to operate the motor (41) that rotates the wheel (42) that drives the top cord (30) and the bottom cord (31). Then the top driver (22) and the bottom driver (26) respectively connected to the cords (30,31) selectively open or close the first curtain (20).

When a bottom track (17) is mounted at the bottom of an automobile window, the wheel (42) connected to the motor (41) has two annular grooves and the optional bottom cord (31) is reeved around the wheel (42) in the second annular groove and the corner sheave (13) and the return sheave (14) in the first and second brackets (11, 12) attached to the first and second ends of the bottom track (17). The bottom driver (26) is connected to the bottom edge of the first curtain (20) at the moveable end is mounted in the bottom track (17) and is connected to the bottom cord (31) passing through the bottom track (17).

When opening the first curtain (20), the driving device (40) pulls the top driver (22) and optional bottom driver (26) toward the stationary end of the curtain (20) until the first curtain (20) is open. When the optional open sensor (15) is used, the top driver (22) inside the top track (10) passes the open sensor (15) and the open sensor (15) detects no first curtain (20), the open sensor (15) stops the motor (41), and the first curtain (20) is open.

When closing the first curtain (20), the driving device (40) pulls the at least one top driver (22) away from the stationary end of the curtain (20) until the first curtain (20) is closed. When the optional closed sensor (16) is used, the driver (22) inside the top track (10) reaches the closed sensor (16) and the closed sensor (16) senses the top driver (22), the closed sensor (16) stops the motor, and the first curtain (20) is closed.

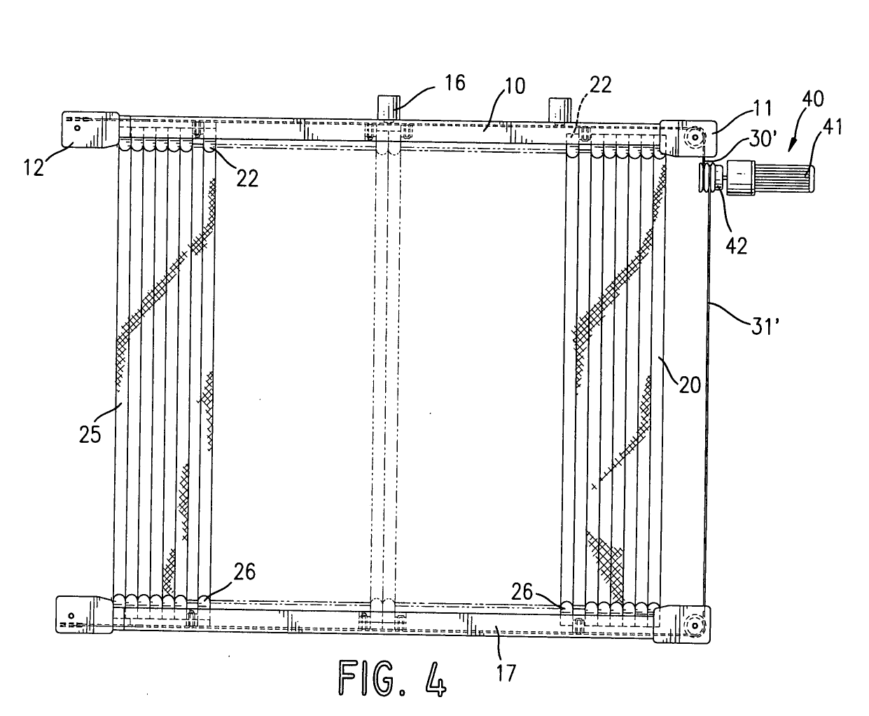

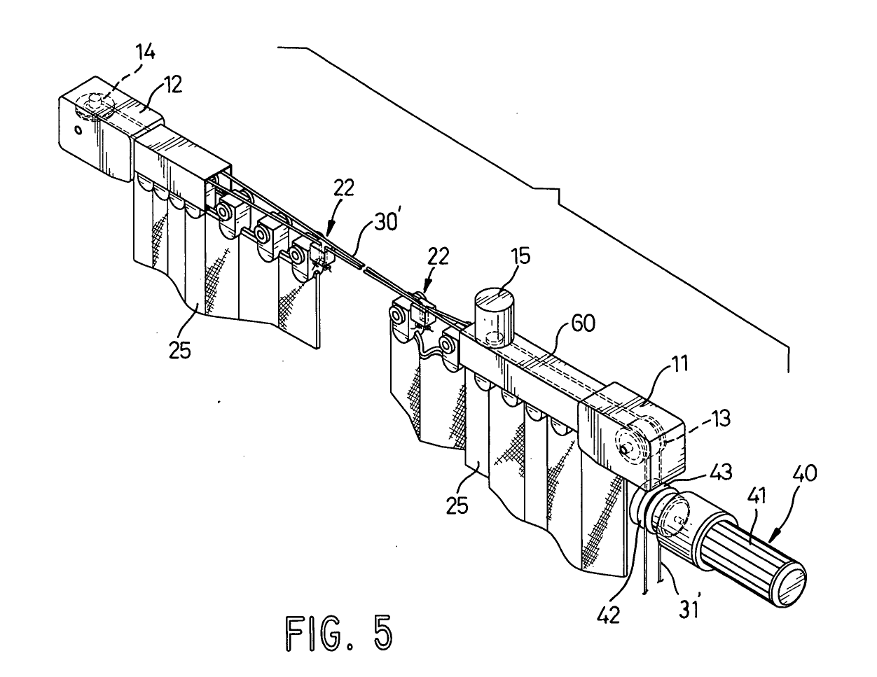

With further reference to FIGS. 4 and 5, another embodiment of an automobile curtain device in accordance with the invention has a first curtain assembly (not numbered) and a second curtain assembly (not numbered) rather than a single curtain assembly described in the previous embodiment, a segmented top cord (30′) and an optional segmented bottom cord (31′).

The first curtain assembly and second curtain assembly are mounted on the top track (10) or alternately between the top track (10) and the optional bottom track (17). The first curtain assembly and second assembly respectively have a first curtain (20) and a second curtain (25), and also respectively have multiple sliding curtain fasteners (21), a top driver (22) and an optional bottom driver (26).

Each curtain (20, 25) has a top edge (not numbered), a bottom edge (not number), a stationary end (not numbered) and a moveable end (not numbered). The stationary end of the first curtain (20) is attached to the first end of the top track (10) and alternately between the top track (10) and the optional bottom track (17). The stationary end of the second curtain (25) is attached to the second end of the top track (10) and alternately between the top track (10) and the optional bottom track (17).

The multiple sliding curtain fasteners (21) and two drivers (22, 26) on each curtain assembly are the same as the multiple sliding curtain fasteners (21) and the two drivers (22, 26) in the embodiment previously described.

The segmented top cord (30′) passes respectively over the corner sheave (13) and around the return sheave (14) in the top track (10), has two parallel segments between the corner sheave (13) and the return sheave (14) and is driven by the wheel (42) attached to the motor (41). When the optional bottom track (17) is used, a segmented bottom cord (31′) passes respectively over the corner sheave (13) and around the return sheave (14) in the bottom track (17), has two parallel segments between the corner sheave (13) and the return sheave (14) and is driven by the wheel (42) attached to the motor (41).

The top driver (22) mounted in the top track (10) and attached to the first curtain assembly is attached to one of the parallel segments of the top cord (30′) in the top track (10). The top driver (26) in the top track (10) and attached to the second curtain assembly is attached to the other parallel segment of the top cord (30′). When present, the two optional bottom drivers (26) in the optional bottom track (17) are attached to segments of the bottom cord (31′) corresponding to the segments in the top track (10).

The optional closed sensor (16) is mounted on the top track (10) halfway between the first and second end of the top track (10) and operates the same as the optional closed sensor (16) in the embodiment previously described.

The driving device (40) is the same as the embodiment previously described and drives the segmented top cord (30′) and segmented bottom cord (31′) to selectively close or open the two curtains (20, 25) simultaneously.

Even though numerous characteristics and advantages of the present invention have been set forth in the foregoing description together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An automobile curtain device for automobile windows having tops and bottoms, the automobile curtain device comprising:
a top track for being mounted on the top of an automobile window and having
a first end;
a second end;
a first bracket attached to the first end of the track;
a second bracket attached to the second end of the track;
a corner sheave mounted and rotating vertically in the first bracket and having two swallows;
a return sheave mounted and rotating horizontally in the second bracket;
a first curtain assembly mounted on the top track and having
a first curtain having
a top edge;
a bottom edge;
a stationary end attached to the first end of the top track; and
a moveable end;
multiple sliding curtain fasteners mounted in the top track and attached to the top edge of the first curtain at intervals;
a top driver mounted in the top track, attached to the top edge of the first curtain at the moveable end of the first curtain and having
a mounting portion mounted in the track; and
a sliding portion attached to the first curtain;
a top cord having two ends connected to the mounting portion of the top driver, reeved respectively around the corner sheave and return sheave and mounted in the top track; and
a driving device mounted outside the stationary end of the first curtain below the first end of the top track and having
a motor with a shaft; and
a wheel mounted on the shaft and having at least one annular groove around which the cord passes.

2. The automobile curtain device as claimed in claim 1, further comprising
a bottom track for being mounted on the bottom of an automobile window, connected to the bottom edge of the first curtain and having.
a first end;
a second end;
a first bracket attached to the first end of the bottom track;
a second bracket attached to the second end of the bottom track;
a corner sheave mounted and rotating vertically in the first bracket and having two swallows; and
a return sheave mounted and rotating horizontally in the second bracket of the bottom track;
the first curtain assembly further having
multiple sliding curtain fasteners mounted in the bottom track and attached to the bottom edge of the first curtain at intervals between adjacent sliding curtain fasteners;
a bottom driver mounted in the bottom track, attached to the bottom edge of the first curtain at the moveable end of the first curtain and having
a mounting portion mounted in the bottom track; and
a sliding portion attached to the first curtain;
a bottom cord having two ends connected to the mounting portion of the bottom driver on the bottom track, reeved respectively around the corner sheave and return sheave and mounted in the bottom track.

3. The automobile curtain device as claimed in claim 1, further comprising
an open sensor mounted on the top track near the first bracket; and
a closed sensor mounted on the top track next to the second bracket.

4. The automobile curtain device as claimed in claim 2, further comprising
an open sensor mounted on the top track near the first bracket; and
a closed sensor mounted on the top track next to the second bracket.

5. The automobile curtain device as claimed in claim 1, further comprising
a second curtain assembly mounted on the top track and having
a second curtain having
a top edge;
a bottom edge;
a stationary end attached to the second end of the top track; and
a moveable end;
multiple sliding curtain fasteners mounted in the top track and attached to the bottom edge of the second curtain at intervals between adjacent sliding curtain fasteners;
a top driver mounted in the top track, attached to the top edge of the second curtain at the moveable end of the second curtain and having
a mounting portion mounted in the top track; and
a sliding portion attached to the second curtain;
a segmented top cord having two segments connected to the mounting portions of the two top drivers, reeved respectively around the corner sheave and return sheave in the top track and the wheel on the driving device and mounted in the top track.

6. The automobile curtain device as claimed in claim 5, further comprising
a bottom track for being mounted on the bottom of an automobile window, connected to the bottom edges of the first curtain and the second curtain and having.
a first end;
a second end;
a first bracket attached to the first end of the bottom track;
a second bracket attached to the second end of the bottom track;
a corner sheave mounted and rotating vertically in the first bracket and having two swallows; and
a return sheave mounted and rotating horizontally in the second bracket of the bottom track,
wherein the first curtain assembly and the second curtain assembly further respectively have
multiple sliding curtain fasteners mounted in the bottom track and attached to the bottom edge of a corresponding curtain at intervals between adjacent sliding curtain fasteners; and
a bottom driver mounted in the bottom track, attached to the bottom edge of a corresponding curtain at the moveable end and having
a mounting portion mounted in the bottom track; and
a sliding portion attached to the first curtain;
a segmented bottom cord has two segments connected to the mounting portions of the two bottom drivers on the bottom track, is reeved respectively around the corner sheave and return sheave and is mounted in the bottom track.

7. The automobile curtain device as claimed in claim 5, further comprising an open sensor mounted on the top track near the first bracket, a closed sensor mounted on the top track halfway between the first and second bracket.

8. The automobile curtain device as claimed in claim 6, further comprising an open sensor mounted on the top track near the first bracket, a closed sensor mounted on the top track halfway between the first and second bracket.
